(19) United States
(12) Patent Application Publication
(10) Pub. No.: US 2011/0153868 A1
(43) Pub. Date: Jun. 23, 2011

(54) Cloud-Based Application For Low-Provisioned High-Functionality Mobile Station

(75) Inventors: Michael R. Castleberry, Wheaton, IL (US); James B. Jones, Aurora, IL (US); Douglas A. Deutsch, Naperville, IL (US)

(73) Assignee: Alcatel-Lucent USA Inc., Murry Hill, NJ (US)

(21) Appl. No.: 12/641,884

(22) Filed: Dec. 18, 2009

(51) Int. Cl. G06F 15/16

(52) U.S. Cl. 709/246

(57) ABSTRACT

A communication system includes a low-provisioned high-functionality mobile station, a wireless service provider, Internet, and a PSTN. The wireless service provider includes a mobile smart cloud server that provides applications to the low-provisioned high-functionality mobile station. The mobile smart cloud servers can include servers that allow the low-provisioned high-functionality mobile station to perform voice communications, web browsing applications, and applications for reading email and email attachments.

### FIELD OF THE INVENTION

The present invention relates generally to communication systems, and more particularly to mobile communication systems.

### BACKGROUND OF THE INVENTION

Mobile networks are increasing functionality beyond basic voice and data services. These enhanced applications typically require high-end, complex mobile devices. Adding the necessary processors, memory, and other components to these mobile stations makes them very expensive. This expense is either passed directly to the subscriber via an expensive purchase of the mobile station or by having the wireless service provider subsidize the cost of the mobile station and by having the subscriber sign up for a lengthy and often costly service contract.

Handset technology is often a limiting factor in the release of new technology. Complex mobile devices often prevent or delay the service provider from delivering value-added services due to a service provider waiting until a sufficient number of high-end mobile devices are available to utilize the enhanced service. In addition, the pool of users able to utilize such services is limited to those who own the expensive high-end devices. These users may not be able to afford such services after having to pay for an expensive mobile device.

One proposed solution to the problem of expensive mobile stations is the service offering of the downloading of content and executable files to a mobile station for a license fee. In this scenario, a user eventually reaches the limits of the current device and must limit their consumption of content and/or executable programs or incur the cost of purchasing a newer, more highly-provisioned mobile station.

A further problem with costly and extensively-provisioned mobile phones is the damage that can be done if the mobile phone is lost or stolen, since potentially sensitive data may be located on the mobile phone. In addition, a user can lose access to valuable data if the mobile phone is destroyed or malfunctions.

An additional problem of delivering or downloading applications to an expensive mobile phone is keeping applications on the mobile phone current. For a single user, this means the user must know when to download an updated version. For an enterprise, keeping multiple end user devices and all their applications current presents a daunting IT challenge.

When there are multiple users, there is a need to coordinate the versions of applications running so that the users may share user data amongst themselves. Downloading to many individual devices present an application management problem.

Therefore, a need exists for a method and system for allowing a mobile station to receive new versions of software and data without having the mobile station download content and executables. In addition, a need exists for a method and system of providing voice, data, and multimedia services on a mobile station while minimizing the risk of lost or stolen data on the mobile station should the mobile station be lost, stolen, or damaged.

### BRIEF SUMMARY OF THE INVENTION

An exemplary embodiment of the present invention reduces handset complexity to be consequently as cheap as possible and places the intelligence and applications into a managed network server environment, potentially controlled by a service provider or an Application service provider. This exemplary embodiment allows data assets and applications to be resident in wireless network servers, allowing the commoditization of wireless mobile stations. This dramatically reduces handset costs without negatively impacting service or functionality of the mobile station.

An exemplary embodiment of the present invention performs Application Streaming utilizing a basic mobile station, in which the mobile station performs simple input/output and display functions, optimized for mobile networks. Storing and accessing applications and user files on the cloud instead of on the mobile station also provides value in the form of data security and preservation. Users need not worry about losing data when a handset is lost, is destroyed, or malfunctions. Storage in the network also makes the user profile portable in much the same way that directory numbers are now portable. This avoids manual intervention by a user or a service provider whenever the service or device changes.

An exemplary embodiment of the present invention provides a software and firmware infrastructure that is capable of running on a wide variety of low-provisioned mobile devices and would provide telephony, voice, and data functions via intelligence in a cloud within the wireless network. The mobile device interacts with the Cloud via a simple protocol to inform the Cloud of text entered on the mobile station and also click/touch actions on the mobile station, and also receives screen drawing commands from the Cloud. The low-provisioned mobile device preferably includes enough intelligence to communicate with the cloud and includes codecs to handle any audio/video streamed between itself and the cloud. The low-provisioned mobile device could also be provided in the form of a USB-interfaced device Network Layer Interface (NLI) or integrated into a chipset, thereby allowing any laptop or terminal to provide LTE voice and data.

### BRIEF DESCRIPTION OF THE SEVERAL VIEWS OF THE DRAWINGS

FIG. 1 depicts a communication system including a low-provisioned high-functionality mobile station in accordance with an exemplary embodiment of the present invention.

FIG. 2 depicts a flow diagram for making voice calls utilizing a low-provisioned high-functionality mobile station in accordance with an exemplary embodiment of the present invention.

FIG. 3 depicts a flow diagram for web browsing utilizing a low-provisioned high-functionality mobile station in accordance with an exemplary embodiment of the present invention.

FIG. 4 depicts a flow diagram for reading email messages and attachments utilizing a low-provisioned high-functionality mobile station in accordance with an exemplary embodiment of the present invention.

### DETAILED DESCRIPTION OF THE INVENTION

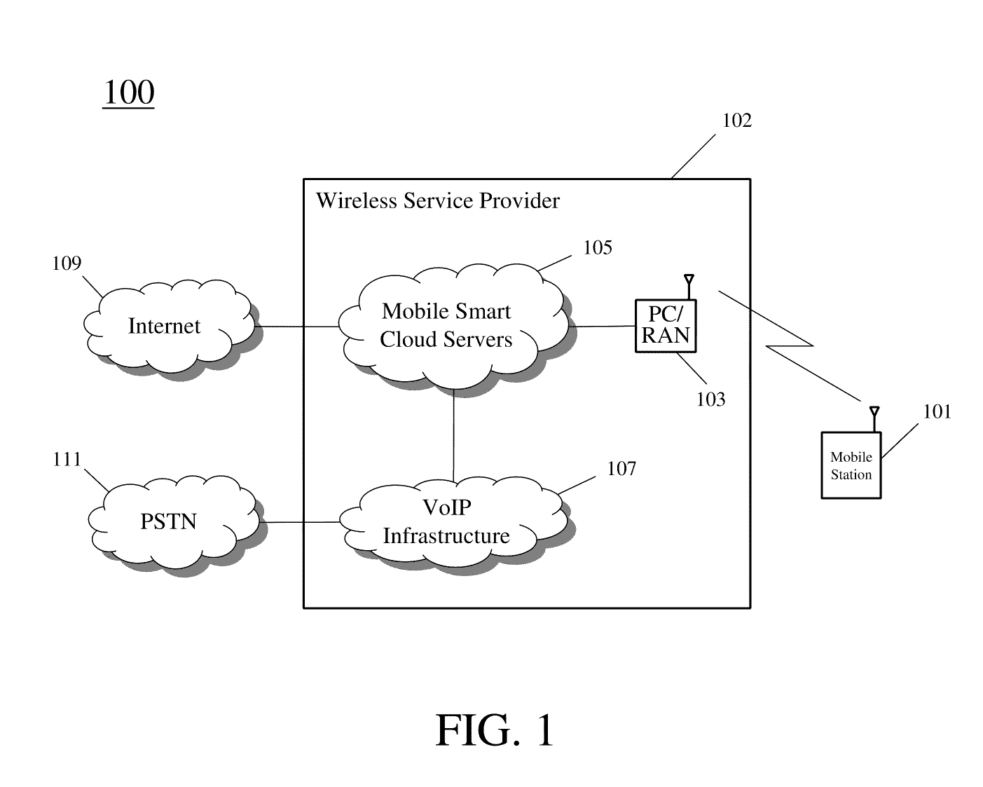

An exemplary embodiment of the present invention can be better understood with reference to FIGS. 1 through 4. FIG. 1 depicts a communication system 100 in accordance with an exemplary embodiment of the present invention. Communication system 100 includes low-provisioned high-functionality mobile station 101, wireless service provider 102, internet 109, and PSTN (public switched telephone network) 111.

In accordance with an exemplary embodiment, low-provisioned high-functionality mobile station 101 is a mobile station supporting communication using a wireless air interface with wireless Packet Core/Radio Access Network (PC/RAN) 103. In an alternate exemplary embodiment, low-provisioned high-functionality mobile station 101 comprises a USB-interfaced device capable of supporting the chosen air interface, such as LTE. In this alternate exemplary embodiment, any terminal or laptop is able to provide the functionality of an LTE phone.

Wireless service provider 102 comprises PC/RAN 103, mobile smart cloud servers 105, and VoIP infrastructure 107.

PC/RAN 103 is an LTE base station (along with supporting packet core network elements) that communicates over the air with mobile station 101. In an exemplary embodiment, PC/RAN 103 comprises the wireless infrastructure that provides for communication between mobile station 101 and mobile smart cloud servers 105. In an exemplary embodiment, PC/RAN 103 is an E-UTRAN and ePC in an LTE/4G wireless communication network.

In accordance with an exemplary embodiment, mobile smart cloud servers 105 interact as part of wireless service provider 102 and provide applications to mobile devices, and embody a client interface to low-provisioned high-functionality mobile station 101.

Mobile smart cloud servers 105 can include servers that allow a low-provisioned high-functionality mobile station to perform voice communications. In this embodiment, the mobile smart cloud server is a smart cloud voice client. The smart cloud voice client can, for example, be a SIP User Agent, which provides SIP UAC/UAS functionality in the cloud.

Mobile smart cloud servers 105 can alternately provide web browsing applications for a low-provisioned high-functionality mobile station. In this embodiment, the mobile smart cloud server includes a web browser and web-supporting software, such as “JAVA”, in which “JAVA” applets execute within mobile smart cloud servers 105.

Mobile smart cloud servers 105 can alternately provide applications for reading email and email attachments for a low-provisioned high-functionality mobile station. In this embodiment, the mobile smart cloud server includes user files, an email application, and programs for reading email attachments, such as word processors, spreadsheets, image files, etc.

Mobile smart cloud servers 105 can also implement an advanced “telephone relay service” by performing Text-to-Speech for the visually impaired or Speech-to-text for the hearing impaired, thus enabling services compliant with the Americans with Disabilities Act.

Mobile smart cloud servers 105 can also provide real-time software-driven language translation services for Voice-to-Voice, voice-to-text and text-to-voice services.

In an exemplary embodiment, mobile station cloud servers 105 include redundancy and load balancing to provide 99.999% availability and extremely low blocking probability. Further, mobile station cloud servers 105 are preferably optimized for mobile usage. For example, mobile station cloud servers 105 can preferably accommodate brief interruptions in air interface coverage and moderate levels of packet loss, delay, and jitter. Further, mobile station cloud servers 105 can include applications provided by wireless service provider 102, such as voice, web browser, and mobile email. Mobile station cloud servers 105 can further include applications provided by third parties. For example, a voice application may act as a SIP endpoint or alternatively hold functionality needed to place calls through the circuit core network of the service provider.

VoIP infrastructure 107 is operably coupled with PSTN 111 and preferably includes an IP Multimedia Subsystem (IMS), a Multimedia GateWay (MGW) and facilitates communication between low-provisioned high-functionality mobile station 101 and other communication units, including both wireless and wireline communication units.

Internet 109 is the publicly available interconnected system of networks that connects computers around the world via a standardized Internet Protocol (IP) protocol, such as the TCP/IP protocol.

PSTN 111 is the international collection of interconnected voice-oriented public telephone networks, both commercial and government-owned. The interface between VoIP Infrastructure 107 and PSTN 111 is preferably a SIP interface, but can alternately be an SS7 interface or any other appropriate interface.

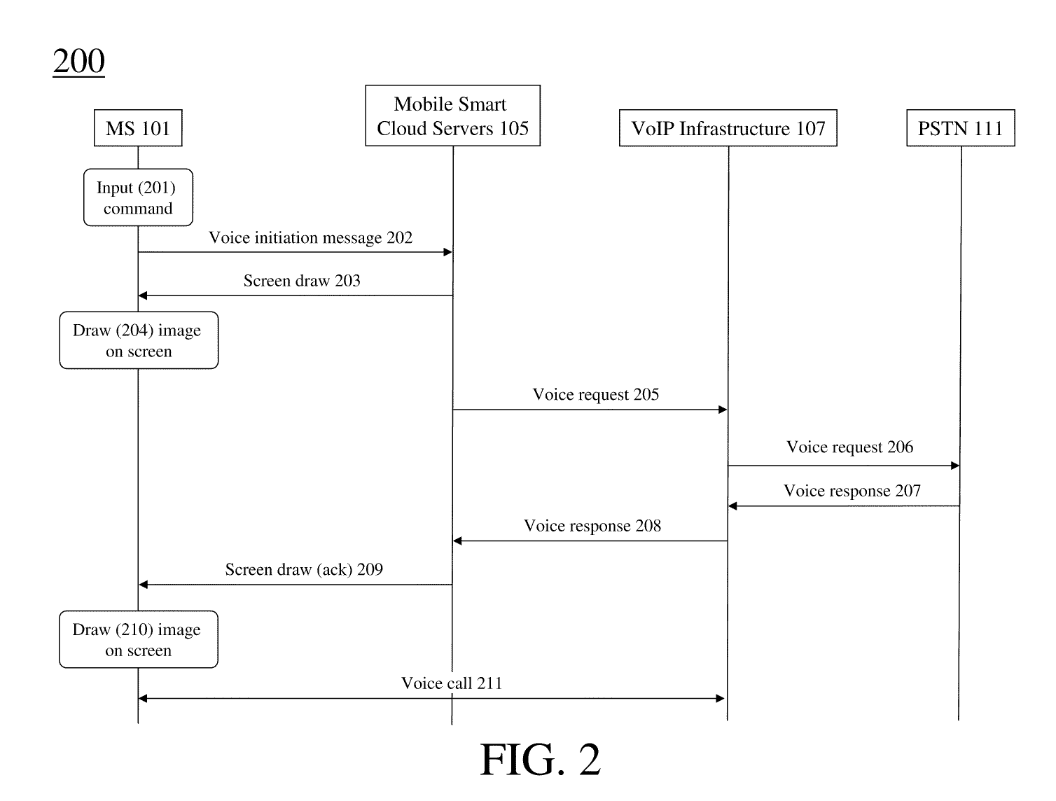

FIG. 2 depicts a flow diagram 200 of a method for making voice calls utilizing a low-provisioned high-functionality mobile station in accordance with an exemplary embodiment of the present invention.

A user of mobile station 101 inputs (201) a command on mobile station 101. The inputting can occur via pressing a key on a keypad of mobile station 101, touching the screen of mobile station 101, speaking a voice command, or any other acceptable means of entering data into mobile station 101.

Mobile station 101 sends voice initiation message 202 to mobile smart cloud server 105. Voice initiation message 202 is preferably a cloud server command message sent utilizing TCP/IP that includes the device ID of mobile station 101 and an application request type of voice.

Mobile smart cloud server 105 receives voice initiation message 202 and, after verifying that mobile station 101 is permitted to place a call, sends screen draw message 203 to mobile station 101. In an exemplary embodiment, screen draw message 203 includes the status of the voice initiation request. Screen draw message 203 is preferably a cloud server draw message sent utilizing TCP/IP.

Mobile station 101 receives screen draw message 203. In accordance with an exemplary embodiment, mobile station 101 draws (204) an image on the screen of mobile station 101. Screen draw message 203 instructs mobile station 101 how to draw an image on the screen of mobile station 101. Screen draw message 203 preferably includes a combination of text, vector, attribute and image information. The image displayed on the screen of mobile station 101 preferably appears to a user of mobile station 101 as a typical screen image.

In response to voice initiation message 202, mobile smart cloud server 105 sends voice request 205 to VoIP Infrastructure 107. Voice request 205 is preferably a VoIP client call setup message, such as a SIP invite message.

VoIP Infrastructure 107 receives voice request 205 and sends a voice request message 206 to PSTN 111. In an exemplary embodiment, VoIP Infrastructure 107 acts as a Class 5 local exchange or as a customer-premises ISDN PRI client.

PSTN 111 receives voice request message 206 and performs necessary call establishment steps. PSTN 111 then sends voice response message 207 to VoIP Infrastructure 107.

VoIP Infrastructure 107 sends voice response message 208 to mobile smart cloud server 105. Voice response message 208 is preferably a SIP message.

Mobile smart cloud server 105 sends screen draw message 209. In an exemplary embodiment, screen draw message 209 includes an acknowledgement that the call has been properly established. Mobile smart cloud server 105 can also send additional screen draw messages to mobile station 101. For example, mobile smart cloud server 105 can send a screen draw message for allowing a user to touch the screen to end the call, add an additional user to the call, or end the call.

Mobile station 101 receives screen draw message 209. In accordance with an exemplary embodiment, mobile station 101 draws (210) an image on the screen of mobile station 101. Screen draw message 209 instructs mobile station 101 how to draw an image on the screen of mobile station 101. Screen draw message 209 preferably includes a combination of text, vector, attribute and image information.

A voice call 211 is now established between low-provisioned high-functionality mobile station 101 and the called party and is routed through VoIP Infrastructure 107. Mobile smart cloud server 105 streams voice to mobile station 101 over the data connection.

In this exemplary embodiment, low-provisioned high-functionality mobile station 101 includes input, voice coder, and screen drawing capability. Low-provisioned high-functionality mobile station 101 is able to complete a voice call without having any additional software added to it. Because the application processing is occurring in the network, upgrades can be done in the network and take effect in low-provisioned high-functionality mobile stations without having to upgrade the mobile station.

It should be understood that although an outgoing call request has been described in this embodiment, that similar processing can occur to provide for high-functionality mobile station 101 to receive incoming calls as well.

Further, a wide array of additional services can be provided by wireless service provider 102. These include, but are not limited to, personalized ring tone service with the ring tones stored within wireless service provider 102, personal music playback with the music being stored at wireless service provider 102, and broadcast audio or video with the content being broadcast from wireless service provider 102.

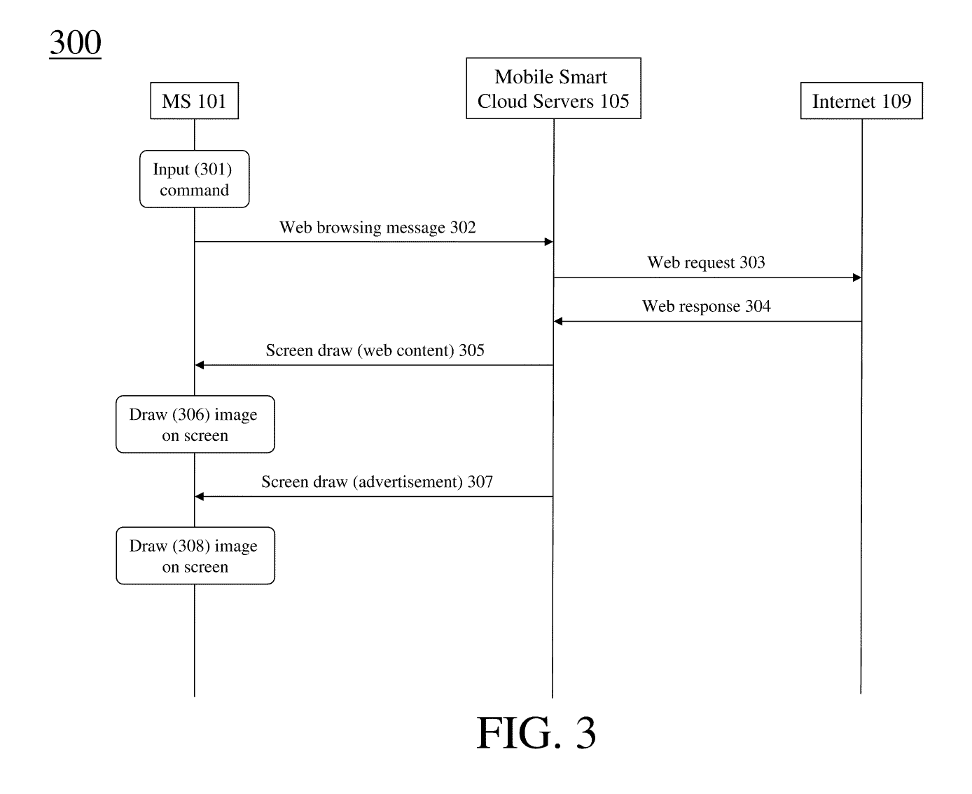

FIG. 3 depicts a flow diagram 300 for web browsing utilizing a low-provisioned high-functionality mobile station in accordance with an exemplary embodiment of the present invention.

A user of mobile station 101 inputs (301) a command on mobile station 101. The inputting can occur via pressing a key on a keypad of mobile station 101, touching the screen of mobile station 101, speaking a voice command, or any other acceptable means of entering data into mobile station 101.

Mobile station 101 sends web browsing message 302 to mobile smart cloud server 105. Web browsing message 302 is preferably a cloud server command message sent utilizing TCP/IP. Web browsing message 302 preferably includes the address of a desired web page by including the Uniform Resource Locator (URL) that specifies where the web page is located and the mechanism for retrieving it.

Mobile smart cloud server 105 receives web browsing message 302. In response to web browsing message 302, mobile smart cloud server 105 sends web request 303 to Internet 109, preferably using HTML.

Internet 109 receives web request 303 and performs necessary steps to retrieve the requested web page. Internet 109 then sends web response message 304 to mobile smart cloud server 105. Web response message 304 preferably includes data associated with the requested web page.

Mobile smart cloud server 105 sends screen draw message 305 to low-provisioned high-functionality mobile station 101. In an exemplary embodiment, screen draw message 305 includes the data from the requested web page. Mobile smart cloud server 105 can also send additional screen draw messages to mobile station 101. For example, mobile smart cloud server 105 can send a screen draw message for allowing a user to touch the screen to request other web pages or enter data to be sent to Internet 109.

Mobile station 101 receives screen draw message 305. In accordance with an exemplary embodiment, mobile station 101 draws (306) an image on the screen of mobile station 101. Screen draw message 305 instructs mobile station 101 how to draw an image on the screen of mobile station 101. Screen draw message 305 preferably includes a combination of text, vector, attribute and image information.

In this exemplary embodiment, low-provisioned high-functionality mobile station 101 includes input and screen drawing capability. Low-provisioned high-functionality mobile station 101 is able to retrieve web pages on Internet 109 without having any additional software added to it. Because the application processing is occurring in the network, upgrades can be done in the network and take effect in low-provisioned high-functionality mobile stations without having to upgrade the mobile station.

In accordance with a further exemplary embodiment, mobile smart cloud server 105 sends screen draw message 307 to low-provisioned high-functionality mobile station 101. Screen draw message 307 preferably includes an advertising message and can include areas for accepting input on mobile station 101. For example, mobile smart cloud server 105 can send a screen draw message for allowing a user to touch the screen to go to a web page of an advertiser providing screen draw message 307.

Mobile station 101 receives screen draw message 307. In accordance with an exemplary embodiment, mobile station 101 draws (308) an image on the screen of mobile station 101. Screen draw message 307 instructs mobile station 101 how to draw an image on the screen of mobile station 101. Screen draw message 307 preferably includes a combination of text, vector, attribute and image information.

It should be understood that the process for sending and drawing advertising messages on mobile station 101 can be done at various places within the process. Further, advertising messages can be used with any of the various exemplary embodiments and can include screen draws or audio clips.

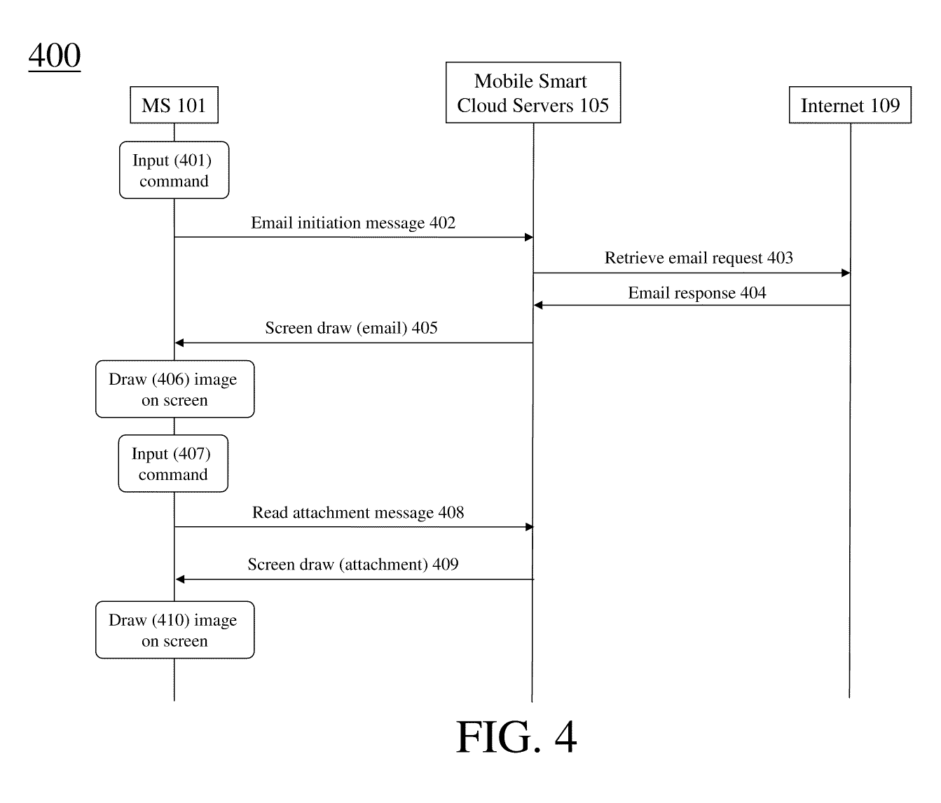

FIG. 4 depicts a flow diagram 400 for reading email messages and attachments utilizing a low-provisioned high-functionality mobile station in accordance with an exemplary embodiment of the present invention.

A user of mobile station 101 inputs (401) a command on mobile station 101. The inputting can occur via pressing a key on a keypad of mobile station 101, touching the screen of mobile station 101, speaking a voice command, or any other acceptable means of entering data into mobile station 101.

Mobile station 101 sends email initiation message 402 to mobile smart cloud server 105. Email initiation message 402 is preferably a cloud server command message sent utilizing TCP/IP.

Mobile smart cloud server 105 receives email initiation message 402 and, after verifying that mobile station 101 has the appropriate access to an email server, retrieve email request 403 to Internet 109. Retrieve email request 403 is preferably a VoIP client call setup message, such as a SIP invite message.

Internet 109 receives retrieve email request message 403 and performs necessary steps to retrieve from the requested email account. The email account can be located on mobile smart cloud servers 105 or on Internet 109.

Internet 109 then sends email response message 404 to mobile smart cloud server 105. Email response message 404 preferably includes data associated with the requested email account.

Mobile smart cloud server 105 sends screen draw message 405 to low-provisioned high-functionality mobile station 101. In an exemplary embodiment, screen draw message 405 includes the data from the requested email account. Mobile smart cloud server 105 can also send additional screen draw messages to mobile station 101. For example, mobile smart cloud server 105 can send a screen draw message for allowing a user to touch the screen to read an email, compose an email message, delete a message, or any other function typically associated with email, even though the email server and data are not located in low-provisioned high-functionality mobile station 101.

Mobile station 101 receives screen draw message 405. In accordance with an exemplary embodiment, mobile station 101 draws (406) an image on the screen of mobile station 101. Screen draw message 405 instructs mobile station 101 how to draw an image on the screen of mobile station 101. Screen draw message 405 preferably includes a combination of text, vector, attribute and image information.

In this exemplary embodiment, low-provisioned high-functionality mobile station 101 includes input and screen drawing capability. Low-provisioned high-functionality mobile station 101 is able to read and compose email message without having any additional software added to it. Because the application processing is occurring in the network, upgrades can be done in the network and take effect in low-provisioned high-functionality mobile stations without having to upgrade the mobile station. Further, if low-provisioned high-functionality mobile station 101 becomes lost, stolen, or otherwise inoperable, a user can still access all email messages for their email account utilizing a different mobile station. This provides for enhanced security as well as less downtime in the event of a problem with their mobile station.

In one exemplary embodiment, the image drawn on the screen of mobile station 101 at step 406 can include an apparent button on the screen of mobile station 101. A user of mobile station 101 can touch the portion of the screen associated with the apparent button to initiate an action. In this exemplary embodiment, the button is associated with reading an attachment of an email. By touching that portion of the screen of mobile station 101, a user of mobile station 101 inputs (407) a command on mobile station 101. The inputting can alternately occur via pressing a key on a keypad of mobile station 101, speaking a voice command, or any other acceptable means of entering data into mobile station 101.

Mobile station 101 sends read attachment message 408 to mobile smart cloud server 105. Read attachment message 408 is preferably a cloud server command message sent utilizing TCP/IP.

Mobile smart cloud server 105 sends screen draw message 409 to low-provisioned high-functionality mobile station 101. In an exemplary embodiment, screen draw message 409 includes the data from the requested attachment. Mobile smart cloud server 105 can also send additional screen draw messages to mobile station 101. For example, mobile smart cloud server 105 can send a screen draw message for allowing a user to touch the screen to print the attachment, even though the application and data are not located in low-provisioned high-functionality mobile station 101.

Mobile station 101 receives screen draw message 409 and draws (410) an image on the screen of mobile station 101. Screen draw message 409 instructs mobile station 101 how to draw an image on the screen of mobile station 101. Screen draw message 307 preferably includes a combination of text, vector, attribute and image information.

An exemplary embodiment of the present invention provides several advantages over the prior art. Service providers can provide service at a lower cost and with higher revenues. Mobile stations will be less expensive and additional revenue can be realized through application leasing and embedded targeted advertising.

In addition, administrative and security gains are realized as a result of hosting applications in the mobile smart cloud servers.

Further, upgrades in features or services can be done in the network and provide enhanced services to subscribers without requiring subscribers to upgrade their mobile devices.

While this invention has been described in terms of certain examples thereof, it is not intended that it be limited to the above description, but rather only to the extent set forth in the claims that follow.

We claim:

1. A mobile smart cloud server comprising:
an input port for receiving a message from a low-provisioned high-functionality mobile station;
a processor for determining a screen image based upon the message; and
an output port for sending the screen image to the low-provisioned high-functionality mobile station.

2. A mobile smart cloud server in accordance with claim 1, wherein the processor utilizes a software application to determine the screen image.

3. A mobile smart cloud server in accordance with claim 2, wherein the software application is a web browsing application.

4. A mobile smart cloud server in accordance with claim 2, wherein the software application is a voice communication application.

5. A mobile smart cloud server in accordance with claim 4, wherein the voice communication application is a SIP User Agent.

6. A mobile smart cloud server in accordance with claim 4, further comprising a text-to-speech conversion processor.

7. A mobile smart cloud server in accordance with claim 4, further comprising a speech-to-text conversion processor.

8. A mobile smart cloud server in accordance with claim 4, further comprising a real-time software-driven language translation service.

9. A mobile smart cloud server in accordance with claim 8, wherein the real-time software-driven language translation service comprises voice-to-voice translation service.

10. A mobile smart cloud server in accordance with claim 8, wherein the real-time software-driven language translation service comprises voice-to-text translation service.

11. A mobile smart cloud server in accordance with claim 8, wherein the real-time software-driven language translation service comprises text-to-voice translation service.

12. A mobile smart cloud server in accordance with claim 2, wherein the software application is an email application.

13. A mobile smart cloud server in accordance with claim 2, wherein the software application is an application for opening email attachments.

14. A mobile smart cloud server in accordance with claim 1, wherein the processor utilizes application data to determine the screen image.

15. A low-provisioned high-functionality mobile station comprising:
an input device for accepting commands from a user of the low-provisioned high-functionality mobile station;
a transmitter for sending messages to a mobile smart cloud server;
a receiver for receiving a screen image from the mobile smart cloud server; and
a display for displaying the screen image.

16. A low-provisioned high-functionality mobile station in accordance with claim 15, the low-provisioned high-functionality mobile station further comprising a voice coder.

17. A low-provisioned high-functionality mobile station in accordance with claim 15, wherein the transmitter comprises a USB-interfaced device.

18. A low-provisioned high-functionality mobile station in accordance with claim 17, wherein the USB-interfaced device comprises a Network Layer Interface (NLI) device.

19. A low-provisioned high-functionality mobile station in accordance with claim 18, wherein the NLI device is integrated into a chipset.

20. A method for providing applications from a mobile smart cloud server to a low-provisioned high-functionality mobile station, the method comprising:
receiving a message from the low-provisioned high-functionality mobile station at the mobile smart cloud server;
determining at the mobile smart cloud server a screen image to be displayed on the low-provisioned high-functionality mobile station based upon the message;
sending the screen image from the mobile smart cloud server to the low-provisioned high-functionality mobile station; and
displaying the screen image on the low-provisioned high-functionality mobile station.
